(19) United States
(12) Patent Application Publication
(10) Pub. No.: US 2014/0337284 A1
(43) Pub. Date: Nov. 13, 2014

(54) SYNCHRONIZING FOLDERS USING A SHADOW FOLDER HIERARCHY

(71) Applicant: Eric ORTH, Kirkland, WA (US)

(72) Inventor: Eric ORTH, Kirkland, WA (US)

(73) Assignee: GOOGLE INC., Mountain View, CA (US)

(21) Appl. No.: 13/455,074

(22) Filed: Apr. 24, 2012

(51) Int. Cl. G06F 7/00; G06F 17/30

(52) U.S. Cl. 707/610; 707/803; 707/E17.005; 707/E17.032

(57) ABSTRACT

A computer-implemented method for managing folders is provided. The method includes receiving, from a server, folder hierarchy data of hierarchical folders, and creating a shadow folder hierarchy in a first section of a local folder hierarchy based on the received folder hierarchy data, where the first section is not visible to the user. The method also includes receiving, from the server, visibility data for determining, out of the hierarchical folders, display folders to display to a user. The method further includes determining the display folders based on the visibility data, and creating a visible folder hierarchy comprising the display folders in a second section of the local folder hierarchy based on the shadow folder hierarchy, where the second section is visible to the user. Systems and machine-readable media are also provided.

### TECHNICAL FIELD

The present disclosure generally relates to synchronizing contents between a client and a server, and more particularly to synchronizing folders that contain contents to be displayed to a user.

### BACKGROUND

Data may be organized in hierarchical folders, and more than one copy of such data may be stored in different systems. Synchronization may be performed to keep the data stored in the different systems to be consistent with each other.

### SUMMARY

According to an aspect of the present disclosure, a computer-implemented method for managing folders is provided. The method includes receiving from a server folder hierarchy data of hierarchical folders, and creating a shadow folder hierarchy in a first section of a local folder hierarchy based on the received folder hierarchy data. The first section is not visible to a user. The method also includes receiving, from the server, visibility data for determining, out of the hierarchical folders, display folders to display to a user. The method further includes determining the display folders based on the visibility data, and creating a visible folder hierarchy in a second section of the local folder hierarchy based on the shadow folder hierarchy. The visible folder hierarchy includes the display folders, and the second section is visible to the user.

According to another aspect of the present disclosure, a system for managing folders is provided. The system includes a memory storing executable instructions and a processor. The processor is configured to execute the stored executable instructions to receive, from a server, folder hierarchy data of hierarchical folders, and create a shadow folder hierarchy in a first section of a local folder hierarchy based on the received folder hierarchy data. The first section is not visible to the user. The processor is also configured to receive, from the server, visibility data for determining, out of the hierarchical folders, display folders to display to a user. The processor is further configured to determine the display folders based on the visibility, and create a visible folder hierarchy comprising the display folders in a second section of the local folder hierarchy based on the shadow folder hierarchy. The second section is visible to the user. The processor is yet further configured to receive display content data associated with the display folders, and store the display content data in corresponding folders of the display folders.

According to a further aspect of the disclosure, a machine-readable storage medium including machine-readable instructions for causing a processor to execute a method for synchronizing folders using a shadow folder hierarchy is provided. The method includes receiving, from a server, folder hierarchy data of hierarchical folders, and creating a shadow folder hierarchy in a first section of a local folder hierarchy based on the received folder hierarchy data, where the first section is not visible to the user. The method also includes receiving, from the server, visibility data identifying, out of the hierarchical folders, display folders to display to a user, and copying first sections of the shadow folder hierarchy corresponding to the display folders to a second section of the local folder hierarchy to create a visible folder hierarchy, where the second section of the local folder hierarchy is visible to the user. The method further includes receiving display content data associated with the display folders, and storing the display content data in corresponding folders of the display folders.

### BRIEF DESCRIPTION OF THE DRAWINGS

A detailed description will be made with references to the accompanying drawings:

FIG. 1 illustrates an example system for synchronizing folders using a shadow folder hierarchy (“system”) according to certain aspects of the disclosure.

FIG. 2 is a block diagram illustrating an example server and a client in the system of FIG. 1 according to certain aspects of the disclosure.

FIG. 3 is a conceptual diagram illustrating an example synchronization process of the system according to certain aspects of the disclosure.

FIG. 4 illustrates an example flow diagram of an initial synchronization of data between the server and the client of the system according to certain aspects of the disclosure.

FIG. 5 illustrates an example flow diagram of a routine synchronization of data between the server and the client of the system after the initial synchronization illustrated in FIG. 4 according to certain aspects of the disclosure.

FIG. 6 is a block diagram illustrating an example computer system with which the server and the client of the system may be implemented according to certain aspects of the disclosure.

### DETAILED DESCRIPTION

In the following detailed description, numerous specific details are set forth to provide a full understanding of the subject technology. It will be apparent, however, that implementations of the subject technology may be practiced without some of these specific details. In other instances, well-known structures and techniques have not been shown in detail so as not to obscure the disclosure.

According to the various aspects of the subject technology, systems and methods for synchronizing data using a shadow folder hierarchy (“system”) are provided. In an aspect of the subject disclosure, data to be synchronized is organized in hierarchical folders at a server, and a client which synchronizes the data with the server displays only a subset of the hierarchical folders and their contents to a user (“display folders” and “display contents,” respectively). Since the client only displays a subset of the hierarchical folders and their contents, rather than synchronizing the entire data each time synchronization is performed, the client first receives from the server only the hierarchy information of the hierarchical folders and information necessary to determine the display folders and display contents. Based on such information, the system determines the display folders, and synchronizes only the contents of the display folders (display contents). Therefore, the system avoids unnecessary synchronization of data that will not be shown to the user, thus reducing network traffic associated with the synchronization and increasing the synchronization time.

While the remainder of the description will refer to synchronization of data between a server and a client, the synchronization may occur between or among computer systems having other types of relationships such as, for example, between two servers, between two local clients, and among more than two different servers, clients, or other types of systems.

The data stored at the server that is to be synchronized may include in its hierarchical folders different types of content. For example, one folder may include a plain text document, a different folder may include a picture file, while another folder may include a hypertext markup language (“HTML”) file. The client synchronizes the data with the server, but may display to the user only folders storing a predetermined type of content. The predetermined type of content may be, for example, plain text documents.

The client receives, from the server, a server folder hierarchy which includes the hierarchy information of all the folders to be synchronized. The server folder hierarchy may also include names of the folders, creation dates, and metadata relating to the synchronization status of the folders. The server folder hierarchy is downloaded to a location in a local folder hierarchy of the client which is not visible to a user (“shadow folder hierarchy”). The client also receives visibility data from the server which contains information on what types of content are stored in the hierarchical folders. For example, the visibility data may include a list of documents stored in the folders to be synchronized, along with the type of each document (e.g. plain text, picture, HTML) and what folder each document is stored in.

Based on the visibility data, the client determines which folders store the predetermined types of content to be displayed to the user (“display contents”). After the folders storing the display contents (“display folders”) are determined, the server folder hierarchy of the display folders is copied from the shadow folder hierarchy into a section of the local folder hierarchy which is visible to the user (“visible folder hierarchy”). The client may then receive the display contents to their corresponding display folders in the visible folder hierarchy. In an aspect of the subject disclosure, the visibility data may directly identify the display folders.

The shadow folder hierarchy and the visible folder hierarchy are bi-directionally linked. Changes made to either folder hierarchy may be reflected in the other using the bi-directional link. Reflecting the changes using the bi-directional link may be done in real-time as the changes are made in one folder hierarchy, may be done periodically, or may be done in response to a request. Synchronization operations between the server and the client may be performed against the shadow folder hierarchy. For example, changes to the folder hierarchy at the server are reflected at the shadow folder hierarchy. If a folder in the visible folder hierarchy is affected, then necessary changes may be made on the visible folder hierarchy using the bidirectional link. If a change is made to a folder in the visible folder hierarchy of the client, the change is reflected at the shadow folder hierarchy, and synchronization may be performed against the shadow folder hierarchy to update the server.

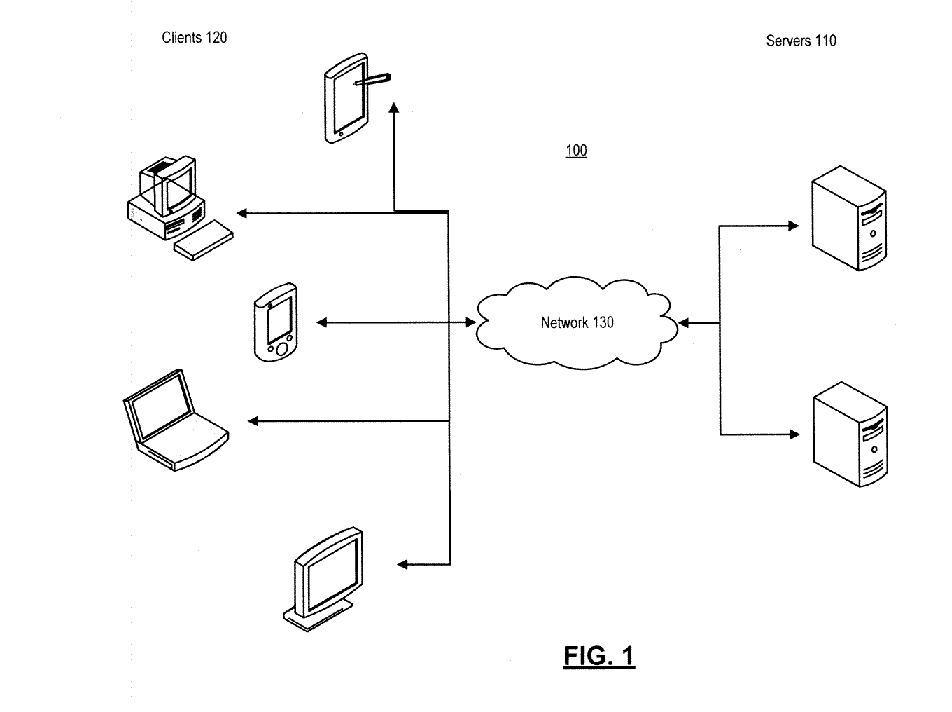

Turning to the drawings, FIG. 1 illustrates an example system 100 for synchronizing folders using a shadow folder hierarchy. The architecture 100 includes servers 110 and clients 120 connected over a network 130. Each of the clients 120 may synchronize data with the servers 110. Data to be synchronized may be stored in a single server of the servers 110 or spread across multiple servers 110. The servers 110 may be any device having a processor, memory, and communications capabilities for storing data in hierarchical folders and communicating the data to clients 120 for synchronization. The clients 120 may be, for example, desktop computers, laptop computers, mobile devices (e.g., a smart phone, tablet computer, or PDA), set top boxes (e.g., for a television), televisions, video game consoles, home appliances (e.g., a refrigerator, microwave oven, washer, or dryer) or any other devices having a processor, memory, and communications capabilities for receiving and storing data synchronized with the servers 110. The network 130 may include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

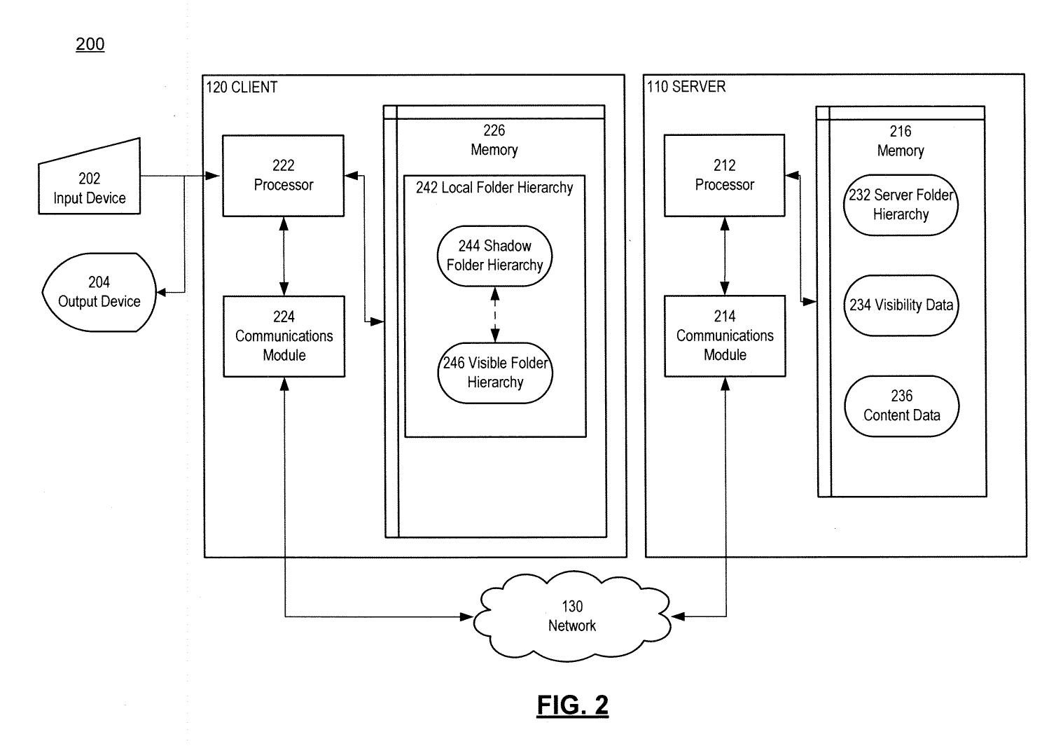

FIG. 2 is a block diagram 200 illustrating an example server 110 and a client 120 in the system 100 of FIG. 1 according to certain aspects of the disclosure. The server 110 and the client 120 are connected over the network 130 via respective communications modules 214 and 224. The communications modules 214 and 224 are configured to interface with the network 130 to send and receive information, such as data, requests, responses, and commands to the other devices or systems on the network. The communications modules 214 and 224 may be, for example, modems, Ethernet cards or mobile broadband adaptors.

The server 110 includes a processor 212, the communications module 214 and a memory 216 that includes a server folder hierarchy 232, visibility data 234, and content data 236. The server folder hierarchy 232 includes folder hierarchy data of all the folders stored in the server 110 that are to be synchronized. The visibility data 234 includes information such as types of data stored in the folders of the server folder hierarchy 232, which is used by the system to determine the display folders and display contents. The visibility data 234 may also include identifiers for directly identifying the display folders. The content data 236 are data stored inside the folders of the server folder hierarchy 232.

The client 120 includes a processor 222, the communications module 224, and a memory 226 that includes a local folder hierarchy 242. The local folder hierarchy 242 may include the shadow folder hierarchy 244 and the visible folder hierarchy 246 after an initial synchronization between the server 110 and the client 120 according to the various aspects of the subject technology. As discussed above, the folder hierarchies 244 and 246 may be bi-directionally linked. The client 120 also may include an input device 202, such as a keyboard, touch screen, or mouse, to receive user inputs. The client further may include an output device 204, such as a monitor, printer, or projector, to display the display folders and contents to the user.

Instructions for causing the processors 212 and 222 to synchronize data between the server 110 and the client 120 are also stored in the memories 216 and 226. The instructions may be spread across the memories 216 and 226, or may be stored entirely in either memory 216 or 226. In an aspect, the instructions may be physically coded to the processors 212 and 222. The instructions may be spread across the processors 212 and 222, or may be entirely encoded in either processor 212 or 222.

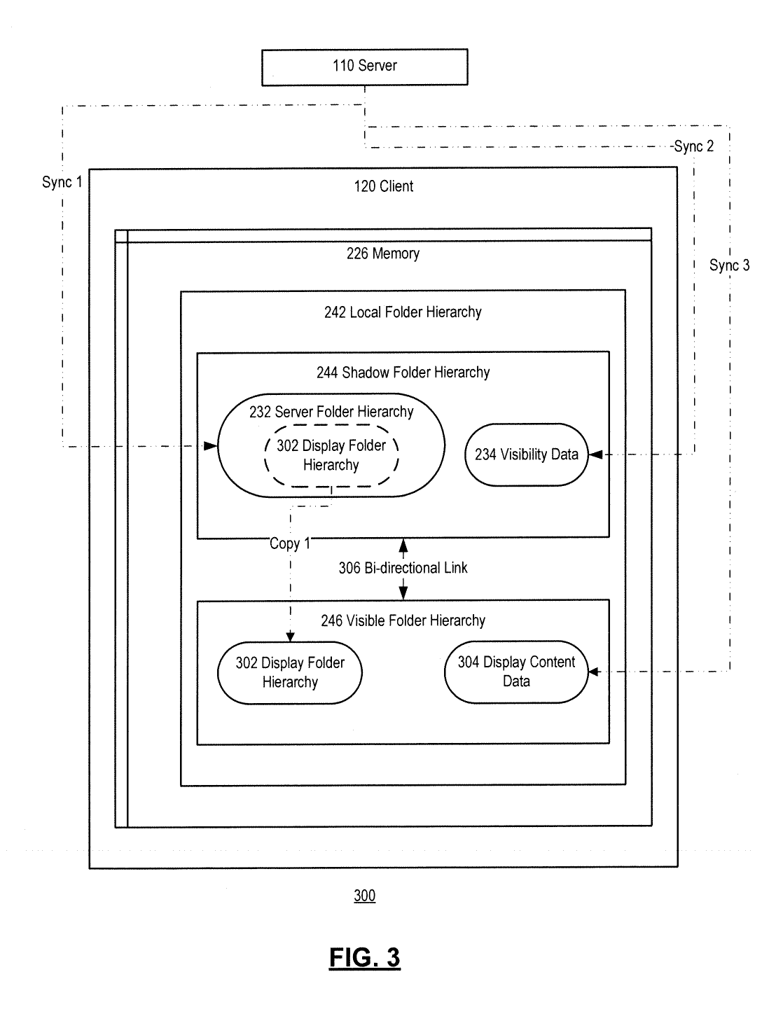

FIG. 3 is a conceptual diagram 300 illustrating an example synchronization process of the system 100. For clarity purposes, the details of the server 110, the processor 222 and communications module 224 of the client 120 are omitted and not shown in the diagram 300.

When synchronizing data between the server 110 and the client 120, the processor 222 of the client 120 executes instructions to, for example, receive the server folder hierarchy 232 from the server 110. The data flow for this step is shown as “Sync 1” in the diagram 300. The shadow folder hierarchy 244 is created in the local folder hierarchy 242 in a section invisible to the user, and the server folder hierarchy 232 is stored in the shadow folder hierarchy. The server folder hierarchy 232 stored in the shadow folder hierarchy 244 stores the hierarchy information of all the folders to be synchronized, including the display folders and folders that will not be shown to the user.

The shadow folder hierarchy 244 may also include other information relating to the folders being synchronized such as, for example, names of the folders, creation dates, last modification dates, identity of the user who created the folder, and identity of the user who last modified the folder. The shadow folder hierarchy 244 may also include synchronization metadata regarding the synchronization status of the server folder hierarchy 232. Such metadata may include, for example, last synchronization date, a change indicator indicating whether a change has occurred since last synchronization, and a unique change identifier identifying the latest synchronization performed on the server folder hierarchy 232. The unique change identifier may be compared with a counterpart identifier at the server 110 to determine the most current version of data to be synchronized. The metadata may be part of the server folder hierarchy 232, or may be stored separately in the shadow folder hierarchy 244. The metadata may also include the synchronization status information of the content data 236 associated with the folders of the server folder hierarchy 232.

The processor 222 also executes instructions to receive the visibility data 234 from the server 110. This data flow is shown as “Sync 2” in the diagram 300. The visibility data 234 is stored in the shadow folder hierarchy 244, and is used to determine the display folder hierarchy 302 including the display folders among the folders of the server folder hierarchy 232. The display folder hierarchy 302 may be, for example, the display folders and folders of the server folder hierarchy 232 that are above the display folders in the hierarchy. The visibility data 234 identifies the type of content data 236 stored in each folder of the server folder hierarchy 232. For example, the visibility data 234 includes a list of contents of the content data 236. The visibility data 234 also indicates the type of each content of the content data 236 and the folder of the server folder hierarchy 232 associated with each content. The different types of contents may include, for example, plain text documents, word processor files (e.g., .doc), spread sheet files (.xls), presentation files (.ppt), still image files (e.g., .jpg, .gif, .bmp), motion picture files (e.g., .avi, .mp4, .mkv), audio files (e.g., .mp3), HTML files, binary files, and portable document format (“PDF”) files.

The processor 222 further executes instructions to determine the display folder hierarchy 302 including the display folders based on the visibility data 234. As discussed above, the display folders are the folders storing the display contents, contents of a predetermined type that are to be displayed to the user. The predetermined type of contents may be, for example, plain text documents. After the display folders are determined, the display folder hierarchy 302 which includes the display folders is copied to a visible section of the local folder hierarchy 242, creating a visible folder hierarchy 246. This data flow is shown as “Copy 1” in the diagram 300.

The shadow folder hierarchy 244 and the visible folder hierarchy 246 are linked by a bi-directional link 306. Using the bi-directional link 306, changes made in either hierarchy 244 or 246 may be reflected on the other. For example, if the display folder hierarchy 302 stored in the visible folder hierarchy 246 receives a change from the user (e.g., user changes a name of a display folder), then the change may be reflected at its counterpart section of the server folder hierarchy 232 in the shadow folder hierarchy 244. As discussed above, the server folder hierarchy 232 of the shadow folder hierarchy 244 includes the folder hierarchy information of all folders to be synchronized, including the display folders and the folders that are not shown to the user. If a new folder of the server folder hierarchy 232 is to be displayed to the user (e.g., a folder previously storing non-display content now stores a display content and thus became a display folder), then the folder hierarchy information corresponding to the new folder may be copied from the shadow folder hierarchy 244 to the visible folder hierarchy 246 using the bi-directional link 306, without having to receive the changed hierarchy information from the server 110.

The processor 222 further executes instructions to receive the display contents that are stored in the display folders and are displayed to the user. As discussed above, the contents of the content data 236 that are of the predetermined type are determined as the display contents to be displayed to the user. Thus from the content data 236 of the server 110, the client 120 receives the display content data 304 representing the display contents. The display content data 304 are stored directly into the visible folder hierarchy 246 in the corresponding display folders. This data flow is shown as “Sync 3” in the diagram 300. “Sync 1”, “Sync 2” and “Sync 3” may be performed all in a single synchronization process, or as three individual processes. “Sync 1” and “Sync 2” may be performed in a single synchronization process with a separate “Sync 3”, or “Sync 1” may be separately performed while “Sync 2” and “Sync 3” are performed in a single synchronization process.

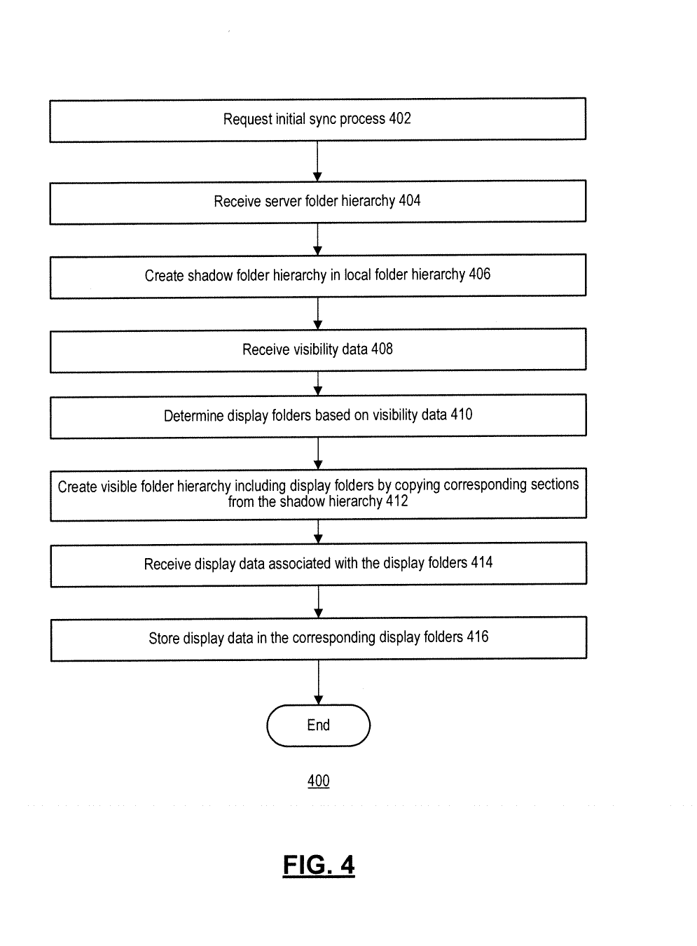

FIG. 4 illustrates an example flow diagram 400 of an initial synchronization of data between the server 110 and the client 120 according to certain aspects of the disclosure. In step 402, client 120 requests an initial synchronization process. In other aspects, the initial synchronization process may be initiated by the server 110 or by the user. In step 404, the client 120 receives from the server 110 the server folder hierarchy 232 representing the folders to be synchronized between the server and the client. In step 406, the shadow folder hierarchy is created in the invisible section of the local folder hierarchy 242, and the server folder hierarchy 232 is stored in the shadow folder hierarchy 244. In step 408, the visibility data 234 is received from the server 110. As discussed above, the visibility data 234 includes information for determining the display contents and the display folders storing the display contents. In an aspect, receiving the server folder hierarchy 232 in step 404 and receiving the visibility data 234 in step 408 are part of two separate synchronization processes. The two synchronization steps 404 and 408 may be performed right after one another, or may be performed with some time in between. In another aspect, the two steps 404 and 408 may be part of a single synchronization process.

In step 410, the display folders are determined based on the visibility data 234. For example, folders of the server folder hierarchy 232 storing plain text documents may be determined as the display folders. The display folder hierarchy 302 is copied from the shadow folder hierarchy 244 into the visible folder hierarchy 246. The visibility data 234 may also be copied to the visible folder hierarchy 246. The display folder hierarchy 302 copied to the visible folder hierarchy 246 and its counterpart in the server folder hierarchy 232 stored in the shadow folder hierarchy 244 are bi-directionally linked via the bi-directional link 306. Through the bi-directional link 306, the hierarchies 244 and 246 may be kept consistent with each other as changes are being made. After the initial synchronization process, the synchronization of the server folder hierarchy 232 between the server 110 and the client 120 is made against the shadow folder hierarchy 244, and any changes to the shadow folder hierarchy 244 which affect the counterparts in the visible folder hierarchy 246 are made using the bi-directional link 306. Synchronization of the visibility data 234 is also made against the shadow folder hierarchy 244. Changes made by the user at the visible folder hierarchy 246 are also reflected at the shadow folder hierarchy 244 via the bi-directional link 306, and are synchronized with the server 110.

In step 414, display content data 304 including the contents of the predetermined type determined in step 410 (e.g., plain text documents) are received, and in step 416, are stored directly into the visible folder hierarchy 246 in the corresponding display folder of the display folder hierarchy 302. Contents which are not of the predetermined type determined in step 410 are not received in step 414. Step 414 may be part of the synchronization process in which the step 408 occurs (receiving the visibility data 234), and is different from the synchronization process in which step 404 occurs (receiving server folder hierarchy 232). Thus the complete synchronization process may occur in two different synchronization processes, where in the first process the server folder hierarchy 232 is synchronized, and in the second process the visibility data 234 and the display content data 304 is synchronized. All three steps 404, 408 and 414 may be parts of three different synchronization processes, or may be part of a single synchronization process.

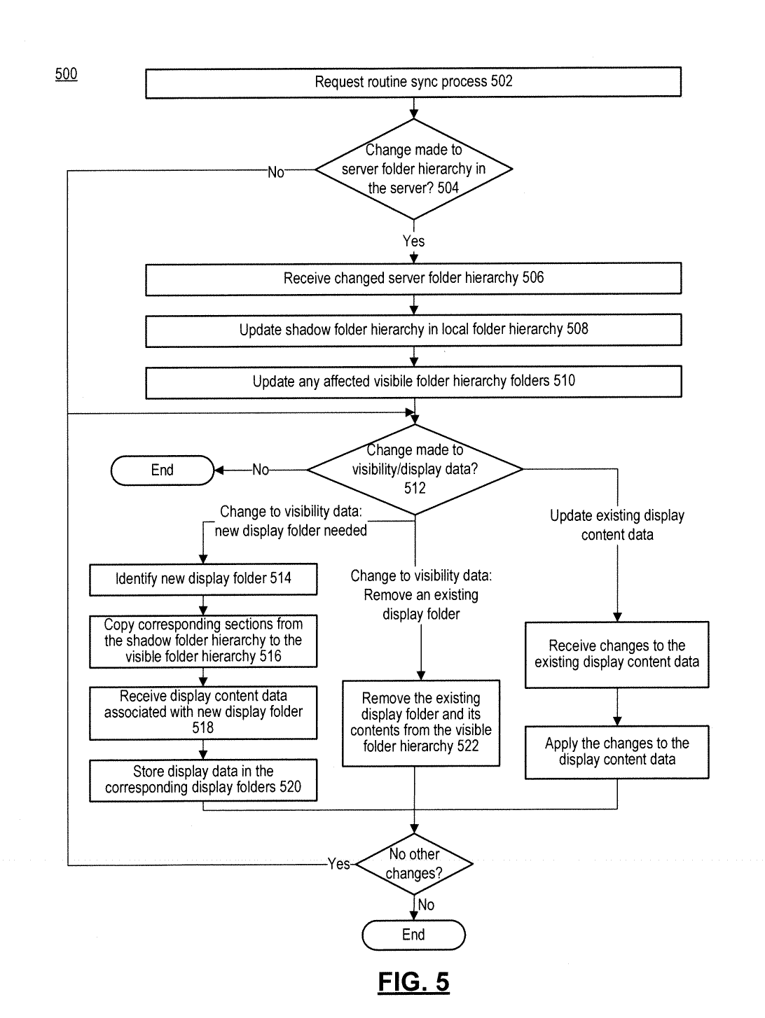

FIG. 5 illustrates an example flow diagram 500 of a synchronization of data between the server 110 and the client 120 after the initial synchronization shown in FIG. 4 according to certain aspects of the disclosure. In step 502, the client 120 requests a routine synchronization with the server 110. Routine synchronization requests may be made periodically in predetermined intervals. For example, routine synchronization requests may be made every one hour. Other intervals may also be used. In step 504, determination is made whether the server folder hierarchy 232 has changed in the server 110 since the last synchronization. Such determination may be made, for example, using the synchronization metadata discussed above. If a change at the server 110 is determined, in step 506, the changed server folder hierarchy 232 is received from the server 110 at the system 120. In step 508, the shadow folder hierarchy 244 is updated with the changed server folder hierarchy 232 received in step 506. In step 510, if a corresponding display folder in the visible folder hierarchy 246 is affected in the changed server folder hierarchy 232, then the display folder is updated via the bi-directional link 306.

After step 510, or if no changes are determined in step 504, determination is made in step 512 whether changes are made to the visibility data 234 and/or the display contents in the content data 236 of the server 110. If no changes are determined, then the routine synchronization process ends.

In step 512, a change in the visibility data 234 may be determined which indicates that a folder which previously stored non-display content now stores display content. For example, in the example above where the predetermined type of content is the plain text document, a folder previously storing a picture file may now store a plain text document, and thus the folder and its contents now become a display folder and display content. In such case, in step 514, the folder storing the new display content is identified in the server folder hierarchy 232 stored in the shadow folder hierarchy 244. In step 516, the sections of the server folder hierarchy 232 corresponding to the folder identified in step 514 is copied to the visible folder hierarchy 246. In the case of a change of an existing non-display folder to a display folder as described above, there may not be a need to receive new folder hierarchy information from the server 110, since a change from a non-display folder to a display folder is determined based on the content stored in the folder, and the hierarchy information of the folders is not changed.

In step 518, the new display content data 304 representing the new display content is received from the content data 236 of the server 110. In step 520, the new display content data 304 received in step 518 is stored in the corresponding display folder in the visible folder hierarchy 246.

In step 512, a change in the visibility data 234 may be determined which identifies that an existing display folder of the display folder hierarchy 302 no longer stores a display content. In the example above, a folder storing a plain text document may now store a .doc file. In this case, in step 522, the former display folder is removed from the visible folder hierarchy 246 and thus portions of the display folder hierarchy 302 corresponding to the former display folder is removed from the visible folder hierarchy.

In step 512, a change in the display content may be determined in the server 110. For example, grammar may be revised in the plain text document stored in a display folder, but still remains the same type as before (e.g., plain text document). In this case, a change to the display content data 304 is received from the server 110 in step 524. In step 526, the change is applied to the display content data 304 in the visible folder hierarchy 246. The above steps may be repeated from step 512 if other changes remain. If no other changes remain, the routine synchronization process ends.

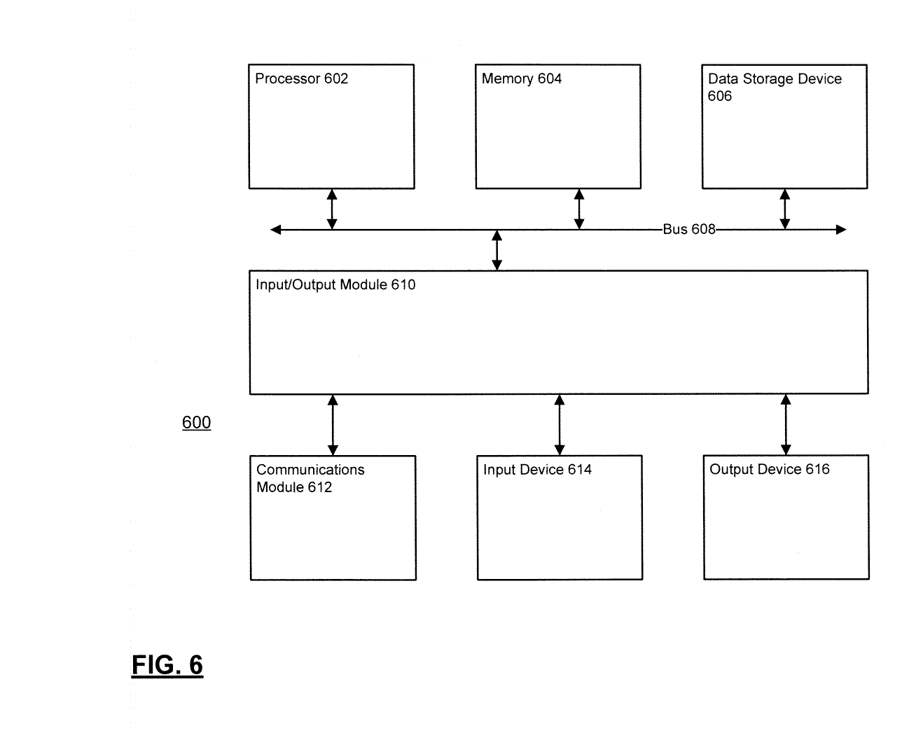

FIG. 6 is a block diagram illustrating an example computer system 600 with which the server 110 and the client 120 of the system may be implemented. In certain aspects, the computer system 600 may be implemented using hardware or a combination of software and hardware, either in a dedicated server, or integrated into another entity, or distributed across multiple entities.

Computer system 600 (e.g., server 110 and client 120) includes a bus 608 or other communication mechanism for communicating information, and a processor 602 (e.g., processors 212 and 222) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memories 216 and 226), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Example input/output modules 610 include data ports such as USB ports. The input/output module 610 is configured to connect to a communications module 612. Example communications modules 612 include networking interface cards, such as Ethernet cards and modems. In certain aspects, the input/output module 610 is configured to connect to a plurality of devices, such as an input device 614 and/or an output device 616. Example input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 616 include display devices, such as a CRT (cathode ray tube) or LCD (liquid crystal display) monitor, for displaying information to the user, and printing devices, such as a laser printer, an ink jet printer or a dot matrix printer.

According to one aspect of the present disclosure, the server 110 and client 120 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject technology described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject technology described in this specification, or any combination of one or more such back end, middleware, or front end components. The components of the system can be interconnected by any form or medium of digital data communication, e.g., a communication network. The communication network (e.g., network 130) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, a floppy disk, flexible disk, hard disk, magnetic tape, any other magnetic medium, a CD-ROM, DVD, any other optical medium, punch cards, paper tape, any other physical medium with patterns of holes, a RAM, PROM, EPROM, FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject technology. Certain features that are described in this specification in the context of separate aspects can also be implemented in combination in a single aspect. Conversely, various features that are described in the context of a single aspect can also be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject technology of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for managing folders, the method comprising:
receiving, from a server, folder hierarchy data of hierarchical folders;
creating a shadow folder hierarchy in a first section of a local folder hierarchy based on the received folder hierarchy data, wherein the first section is not visible to the user;
generating synchronization metadata including information used for synchronizing the hierarchical folders comprising a change indicator, the change indicator indicating whether a change has occurred since a last synchronization;
storing the synchronization metadata in the shadow folder hierarchy;
receiving, from the server, visibility data for determining, out of the hierarchical folders, display folders to display to a user;
determining the display folders based on the visibility data; and
creating a visible folder hierarchy comprising the display folders in a second section of the local folder hierarchy based on the shadow folder hierarchy, wherein the second section is visible to the user.

2. The method of claim 1, further comprising:
receiving display content data associated with the display folders; and
storing the display content data in corresponding folders of the display folders.

3. The method of claim 1, wherein creating the visible folder hierarchy comprises copying first sections of the shadow folder hierarchy corresponding to the display folders to the visible folder hierarchy.

4. The method of claim 1, further comprising:
receiving a change to the visibility data;
determining, based on the change, a new display folder to display to the user; and
copying a second section of the shadow folder hierarchy corresponding to the new display folder to the visible folder hierarchy.

5. The method of claim 1, wherein the visibility data comprises a list of documents stored in the folders to be synchronized, document type information of the documents, and folder information identifying folders corresponding to the documents.

6. (canceled)

7. The method of claim 1, further comprising receiving a change to a section of the visible folder hierarchy, and reflecting the change in a corresponding section of the shadow folder hierarchy.

8. The method of claim 1, further comprising receiving a change to a section of the shadow folder hierarchy, and reflecting the change in a corresponding section of the visible folder hierarchy.

9. A system for managing folders, the system comprising:
a memory storing executable instructions; and
a processor configured to execute the stored executable instructions to:
receive, from a server, folder hierarchy data of hierarchical folders;
create a shadow folder hierarchy in a first section of a local folder hierarchy based on the received folder hierarchy data, wherein the first section is not visible to the user;
generate synchronization metadata including information used for synchronizing the hierarchical folders comprising a unique change identifier, the unique change identifier identifying the latest synchronization performed on the server folder hierarchy;
store the synchronization metadata in the shadow folder hierarchy;
receive, from the server, visibility data for determining, out of the hierarchical folders, display folders to display to a user;
determine the display folders based on the visibility data;
create a visible folder hierarchy comprising the display folders in a second section of the local folder hierarchy based on the shadow folder hierarchy, wherein the second section is visible to the user;
receive display content data associated with the display folders; and
store the display content data in corresponding folders of the display folders.

10. The system of claim 9, wherein creating the visible folder hierarchy comprises copying first sections of the shadow folder hierarchy corresponding to the display folders to the visible folder hierarchy.

11. The system of claim 9, the processor further configured to:
receive a change to the visibility data;
determine a new display folder to display to the user; and
copy a second section of the shadow folder hierarchy corresponding to the new display folder to the visible folder hierarchy.

12. The system of claim 9, wherein the visibility data comprises a list of documents stored in the folders to be synchronized, document type information of the documents, and folder information identifying folders corresponding to the documents.

13. (canceled)

14. The system of claim 9, the processor further configured to receive a change to a folder of display folders in the visible folder hierarchy, and reflect the change in a corresponding section of the shadow folder hierarchy.

15. The system of claim 9, the processor further configured to receive a change to a section of the shadow folder hierarchy, and reflect the change to the section in a corresponding folder of the display folders in the visible folder hierarchy.

16. A non-transitory machine-readable storage medium comprising machine-readable instructions for causing a processor to execute a method for managing folders, the method comprising:
receiving, from a server, folder hierarchy data of hierarchical folders;
creating a shadow folder hierarchy in a first section of a local folder hierarchy based on the received folder hierarchy data, wherein the first section is not visible to the user;
generating synchronization metadata including information used for synchronizing the hierarchical folders comprising a unique change identifier;
storing the synchronization metadata in the shadow folder hierarchy;
comparing the unique change identifier with a counterpart identifier at the server to determine the most current version of the data to be synchronized;
receiving, from the server, visibility data identifying, out of the hierarchical folders, display folders to display to a user;
copying first sections of the shadow folder hierarchy corresponding to the display folders to a second section of the local folder hierarchy to create a visible folder hierarchy, wherein the second section of the local folder hierarchy is visible to the user;
receiving display content data associated with the display folders; and
storing the display content data in corresponding folders of the display folders.

17. The non-transitory machine-readable storage medium of claim 16, the method further comprising:
receiving, from the server, a change to the visibility data, the change identifying a new display folder; and
copying a second section of the shadow folder hierarchy corresponding to the new display folder to the visible folder hierarchy.

18. (canceled)

19. The non-transitory machine-readable storage medium of claim 16, the method further comprising receiving a change to a section of the visible folder hierarchy, and reflecting the change in a corresponding section of the shadow folder hierarchy.

20. The non-transitory machine-readable storage medium of claim 16, the method further comprising receiving a change to a section of the shadow folder hierarchy, and reflecting the change to the section in a corresponding folder of the display folders in the visible folder hierarchy.
